(19) United States
(12) Patent Application Publication
(10) Pub. No.: US 2026/0054601 A1
(43) Pub. Date: Feb. 26, 2026

(54) METHOD OF ADAPTIVELY ADJUSTING FREQUENCY OF WAKING UP FOR DISCHARGING ENERGY TO THE GRID

(71) Applicant: Volvo Car Corporation, Göteborg (SE)

(72) Inventors: Andreas ROPEL, TORSLANDA (SE); Jones SCHÖLD, Göteborg (SE); Fredrik HAAK, Ödsmål (SE); Ali FOTOUHI, Kungsbacka (SE)

(73) Assignee: Volvo Car Corporation, Göteborg (SE)

(21) Appl. No.: 18/810,686

(22) Filed: Aug. 21, 2024

(51) Int. Cl. B60L 55/00; G06Q 50/06; H02J 3/00

(52) U.S. Cl. CPC B60L 55/00; H02J 3/008; B60L 2240/70; B60L 2260/50; G06Q 50/06

(57) ABSTRACT

Embodiments relate to a system and method of adaptively adjusting a frequency of waking up for discharging energy to the grid. The method includes receiving information associated with an energy requirement in an energy source, determining, based on the information, a presence of monetization opportunity associated with discharging a charge from a vehicle battery, and scheduling a time of discharge to maximize a monetary value. The method further includes adjusting a frequency of wakeup based on the monetization opportunity in the received information.

### FIELD OF INVENTION

This disclosure relates to the field of vehicle to grid communication. The disclosure is more particularly related to adjusting a frequency of waking up for discharging energy from vehicle to the grid.

### BACKGROUND

Discharging energy from vehicles back to the grid is getting more popular as users benefit monetarily. However, the pricing provided to the users may vary depending on how many users or other sources (e.g., wind or solar power) are available to provide energy to the grid. Currently, when a vehicle is in a standby mode, the vehicle may notify the grid that it is available for extracting energy. If the grid needs the energy, it can extract energy from the vehicle and provide a monetary compensation to the user of the vehicle. However, to save energy, the vehicle should be in sleep mode. In sleep mode, the vehicle does not know if the grid needs the energy or if there is an opportunity to make a maximum amount of money by providing energy.

Therefore, there is a need for a method for adaptively adjusting a frequency of waking up for discharging energy to the grid.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect, the present disclosure relates to a system comprising: a processor; and a memory operatively coupled to the processor, wherein the memory comprises processor-executable instructions, which on execution, cause the processor to: receive information associated with an energy requirement in an energy source; determine, based on the information, a presence of monetization opportunity associated with discharging a vehicle battery; and schedule a time of discharge to maximize a monetary value.

In another aspect, the present disclosure relates to a system comprising: a processor; a machine learning model communicatively coupled to the processor; and a memory operatively coupled to the processor, wherein the memory comprises processor-executable instructions, which on execution, cause the processor to: receive information associated with an energy requirement in an energy source; and transmit the information to the machine learning model, wherein the machine learning model is operable to: predict, based on the information, a time of discharge to maximize a monetary value for discharging a battery associated with a vehicle; and estimate, based on the time of discharge, a frequency of wakeup for the vehicle.

In one another aspect, the present disclosure relates to a method comprising: receiving, by a processor, information associated with an energy requirement in an energy source; determining, by the processor, based on the information, a presence of monetization opportunity associated with discharging a vehicle battery; and scheduling, by the processor, a time of discharge to maximize a monetary value.

In yet another aspect, the present disclosure relates to a non-transitory computer-readable medium having stored thereon instructions executable by a computer system to perform operations comprising: receiving information associated with an energy requirement in an energy source; determining, based on the information, a presence of monetization opportunity associated with discharging a vehicle battery; and scheduling a time of discharge to maximize a monetary value.

In yet another aspect, the present disclosure relates to a system comprising: a processor; and a memory operatively coupled to the processor, wherein the memory comprises processor-executable instructions, which on execution, cause the processor to: determine a total energy required to service loads connected to an energy source; determine an amount of energy provided by one or more green sources coupled to the energy source; estimate an additional energy required at the energy source based on the total energy required and the amount of energy provided by the one or more green sources; and determine a price per unit of charge based on the estimation.

### BRIEF DESCRIPTION OF THE FIGURES

These and other aspects of the present invention will now be described in more detail, with reference to the appended drawings showing exemplary embodiments of the present invention, in which:

FIG. 1 illustrates a network diagram for vehicle to grid discharging according to an embodiment.

FIG. 2A illustrates a block diagram of a system for adaptively adjusting a frequency of waking up for discharging energy to the grid according to an embodiment.

FIG. 2B shows a block diagram of a battery module in a vehicle according to an embodiment.

FIG. 2C illustrates a functional block diagram of an on-board charger in the battery module according to an embodiment.

FIG. 2D illustrates a block diagram of electronic components of the vehicle according to an embodiment.

FIG. 3 illustrates a message flow diagram between the vehicle and a server according to an embodiment.

FIG. 4A illustrates a block diagram of a system for estimation of frequency of waking up for discharging energy to the grid according to an embodiment

FIG. 4B illustrates an example block diagram for an Artificial Intelligence and Machine Learning (AI/ML) model used in a system for adaptively adjusting the frequency of waking up for discharging energy to the grid according to an embodiment.

FIG. 5A illustrates a structure of the neural network/machine learning model with a feedback loop according to an embodiment.

FIG. 5B illustrates a structure of the neural network/machine learning model with reinforcement learning according to an embodiment.

FIG. 6 illustrates a flow chart describing a method for scheduling discharging energy to the grid according to an embodiment.

FIG. 7 illustrates a block diagram of the system implementing the method for discharging energy to the grid according to an embodiment.

FIG. 8 illustrates a block diagram of the method executed by the non-transitory computer-readable medium for discharging energy to the grid according to an embodiment.

FIG. 9A illustrates the block diagram of the cyber security module in view of the system and server according to an embodiment.

FIG. 9B illustrates an embodiment of the cyber security module according to an embodiment.

FIG. 9C illustrates another embodiment of the cyber security module according to an embodiment.

FIG. 10 illustrates a flow chart of a method for determining a pricing per unit of charge according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more”unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more. ” Furthermore, as used herein, the term “set” is intended to include items (e.g., related items, unrelated items, a combination of related items, and unrelated items, etc.), and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, two or more elements or modules are “integral” or “integrated” if they operate functionally together. Two or more elements are “non-integral”if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The Term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware. In an example, the second component can be an energy source capable of charging a vehicle battery and accepting charge from the vehicle battery.

The term “alert” or “alert signal” refers to a communication to attract attention. An alert may include visual, tactile, audible alert and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users'applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “monitoring” refers to systematic observation and assessment of a system, process, or environment in real-time or near real-time. It involves the regular collection, analysis, and interpretation of data using various sensors. Monitoring may be continuous or adaptive.

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “battery” as used herein refers to a battery system in the vehicle, wherein the battery system may be used for starting the vehicle or may be used for operating the vehicle. The battery system may also be used to enable the vehicle to run.

The term “hibernation mode” as used herein refers to a state of the vehicle or a vehicle mode when the vehicle ignition is OFF and most of the ECUs within the vehicle system are in a sleep state and the vehicle battery in a non-discharging condition.

The term “standby mode” as used herein refers to a state of the vehicle or a vehicle mode when the vehicle ignition is OFF with one or more ECUs within the vehicle system in a wakeup state to receive the information associated with an energy requirement in an energy source, notify the energy source or grid an availability of charge in the vehicle battery for discharging back to the grid, and perform discharging based on a scheduled time of discharge.

The term “frequency of wakeup” or “wakeup cycle” as used herein refers to a frequency at which the vehicle transitions from the hibernation mode to the standby mode. The “frequency of wakeup” is adjusted to maximize the monetary value associated with discharging the vehicle battery.

The term “wakeup signal” as used herein refers to a signal sent from a central control unit or a processor to one or more ECUs in the vehicle system to transition from the hibernation mode to the standby mode based on the frequency of wakeup.

The term “time of discharge” or “discharge time” as used herein refers to a time period during which the vehicle battery discharges a stored charge to the energy source or grid. The wakeup signal based on the frequency of wakeup/adjusted frequency of wakeup enables discharging of the vehicle battery during the scheduled “time of discharge”.

The term “user” as used herein refers to any individual who is a driver or an owner of the vehicle. Broadly, it may encompass any individual having the possession of the vehicle.

Vehicles, majorly used for commuting, require energy for their operation. A vehicle includes a power generation system comprising an alternator and a voltage converter for supplying an operational voltage to one or more of its components. In addition to the power generation system, the vehicle also includes a plurality of battery packs for its operation. The battery packs are capable of storing the energy generated by the power generation system and assist in starting the vehicle and a safe operation of the vehicle. Further, the battery packs can also be charged by plugging-in the vehicle to a charging station or an energy source. The battery packs are also capable of discharging back to the energy source.

With growing need and interest towards green energy and sustainable energy, discharging from the vehicle, i.e., the vehicle battery packs, back to the energy source is gaining more interest. Further, the vehicle owners also benefit monetarily for providing the charge back to the energy source, for example, grid. The price per unit of charge may be determined by the energy source based on factors such as, not limited to, number of vehicles available for providing energy back to the energy source, a time of the day, and the availability of energy from other renewable energy sources connected to the energy source. Therefore, if the energy source does not need energy from the vehicle (e.g., a plugged-in car), there may be a minimum price provided per unit of charge or no monetary return.

Business Problem: Every user expects a maximum monetary gain by giving away excessively stored charge in a vehicle battery back to the energy source/grid. However, as more users are available to provide the charge back to the grid at the same time, the user may not be able to gain maximum monetary value.

Technical Problem: Currently, to provide the energy back to the energy source or grid, the vehicle has to be plugged in and be in a standby mode with the potential to be awakened for communication and discharging. In the standby mode, the energy source/grid is notified that the vehicle is available for extracting energy. If the energy source/grid needs the energy, it can extract the energy from the vehicle. In most cases, the user, i.e., the owner of the vehicle would like a payment for providing the energy back to the energy source. To provide energy back to the energy source the vehicle has to be in the standby mode, even if the energy source/grid does not extract energy from the vehicle. However, to save energy, the vehicle should be in a hibernation mode or a sleep mode (e.g., minimum use of energy with most of the ECUs in shut down condition). In the hibernation mode the vehicle does not communicate with the energy source/grid, and therefore, the vehicle does not know if the energy source/grid needs the energy or if there is an opportunity to make a maximum amount of money by providing energy back to the energy source or grid. Further, in order for the vehicle to wakeup (e.g., transition from the hibernation mode to the standby mode) a certain amount of energy is required. If the vehicle wakes up very frequently there may be wastage of energy. On the other hand, if the vehicle wakes up in a reduced frequency the user may miss out on a chance for making maximum money out of discharging to the energy source/the grid. Hence, there is a need to strike a balance between conserving energy and at the same time not missing the opportunity to get maximum monetization return.

Business Solution: Maximizing monetary gain by adaptively adjusting the frequency of wakeup of the vehicle.

Technical Solution: In one aspect, the present disclosure discusses a method for modifying/adjusting the frequency of waking up based on an artificial intelligence (AI) engine based prediction algorithm. The AI engine predicts a next wakeup time for the vehicle such that maximum monetization is achieved. In some embodiments, the vehicle may wakeup based on an initial frequency of wakeup or an initial wakeup cycle and connect to a cloud/server and retrieve a next frequency of wakeup based on prediction from an AI model. The AI model predicts when the energy source/grid is likely to pay the maximum amount of money, i.e., provide highest monetary return, for discharging the energy and estimates the next frequency of wakeup based on the prediction. The AI model considers various factors such as, how many renewable energy sources (e.g., solar energy, water energy, and wind power) provide energy to the energy source/grid, how many vehicles are plugged in for discharging, a time of the day, and a price per unit charge provided by the energy source for the prediction and estimation of the next frequency of wakeup. For example, the vehicle may have an initial wakeup cycle or a frequency of wakeup of 1 minute, i.e., one or more control units in the vehicle wakeup every minute to communicate with the energy source to notify the energy source regarding the availability of charge for discharging. During the initial wakeup period, the vehicle may receive a new wakeup frequency based on prediction and estimation from the AI model. The AI model may predict, based on the one or more factors, that there is no opportunity to make money by discharging in the next few hours and then adaptively modify/adjust the wakeup frequency calculations such that the vehicle wakes up every 5 minutes.

In an example, a car in the hibernation mode may have its system wakeup every 2 minutes and receive information through an AI model about monetary value provided for discharging for a particular period of time. The system may then schedule a time of discharge to maximize a monetary value and start discharging at the scheduled time of discharge.

In an aspect, the present disclosure relates to a system comprising: a processor; and a memory operatively coupled to the processor, wherein the memory comprises processor-executable instructions, which on execution, cause the processor to: receive information associated with an energy requirement in an energy source; determine, based on the information, a presence of monetization opportunity associated with discharging a vehicle battery; and schedule a time of discharge to maximize a monetary value.

In another aspect, the present disclosure relates to a system comprising: a processor; a machine learning model communicatively coupled to the processor; and a memory operatively coupled to the processor, wherein the memory comprises processor-executable instructions, which on execution, cause the processor to: receive information associated with an energy requirement in an energy source; and transmit the information to the machine learning model, wherein the machine learning model is operable to: predict, based on the information, a time of discharge to maximize a monetary value for discharging a battery associated with a vehicle; and estimate, based on the time of discharge, a frequency of wakeup for the vehicle.

In another aspect, the present disclosure relates to a method comprising: receiving, by a processor, information associated with an energy requirement in an energy source; determining, by the processor, based on the information, a presence of monetization opportunity associated with discharging a vehicle battery; and scheduling, by the processor, a time of discharge to maximize a monetary value.

In yet another aspect, the present disclosure relates to a non-transitory computer-readable medium having stored thereon instructions executable by a computer system to perform operations comprising: receiving information associated with an energy requirement in an energy source; determining, based on the information, a presence of monetization opportunity associated with discharging a vehicle battery; and scheduling a time of discharge to maximize a monetary value.

In yet another aspect, the present disclosure relates to a system comprising: a processor; and a memory operatively coupled to the processor, wherein the memory comprises processor-executable instructions, which on execution, cause the processor to: determine a total energy required to service loads connected to an energy source; determine an amount of energy provided by one or more green sources coupled to the energy source; estimate an additional energy required at the energy source based on the total energy required and the amount of energy provided by the one or more green sources; and determine a price per unit of charge based on the estimation.

Technical Result: Adaptive determination of frequency of wakeup enables efficiently conserving the battery power and at the same time maximizing a monetary gain.

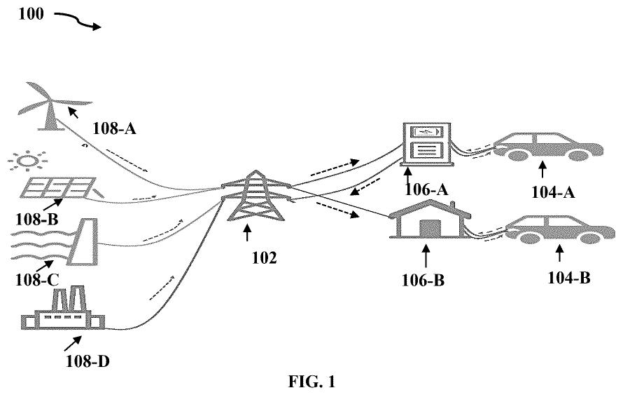

Technical Details Specific to the Technical Solution: FIG. 1 illustrates a network diagram for vehicle to grid discharging according to an embodiment. Network 100 comprises energy source 102, vehicles 104-A, 104-B, plug-in stations 106-A, 106-B, and renewable energy sources 108-A, 108-B, 108-C, and conventional power plants 108-D.

Referring to FIG. 1, energy source 102 may include, for example, at least one of a power grid, a smart grid, a micro grid, a vehicle charging station, and a home-based vehicle charger. Vehicles 104-A, 104-B include such as, not limited to, electric vehicles (EVs), wherein EVs comprise at least one of: battery electric vehicles (BEVs) and plug-in hybrid electric vehicles (PHEVs). EVs include batteries or vehicle batteries enabling the operation of the vehicle. In some embodiments, the vehicle batteries also serve to store additional charge which may be discharged back to energy source 102. EVs when connected to plug-in stations 106-A, 106-B are capable of discharging the additional stored charge from the batteries to energy source 102. In some embodiments, the EVs may also include green energy capturing devices, for example, solar panels, wind turbines, water turbines and other devices capable of capturing kinetic energy (e.g., mechanical motion) mounted on them for generating additional charge which may be stored in the batteries. In some embodiments, plug-in stations 106-A, 106-B may include a centralized charging station serving as a charging point to various EVs. An EV may discharge the stored charge to the plug-in station which may internally store the charge to cater the other EVs or may transfer the charge to energy source 102. In some embodiments, plug-in stations 106-A, 106-B may include a home charging station and the EV may discharge to provide charge to one or more appliances at home.

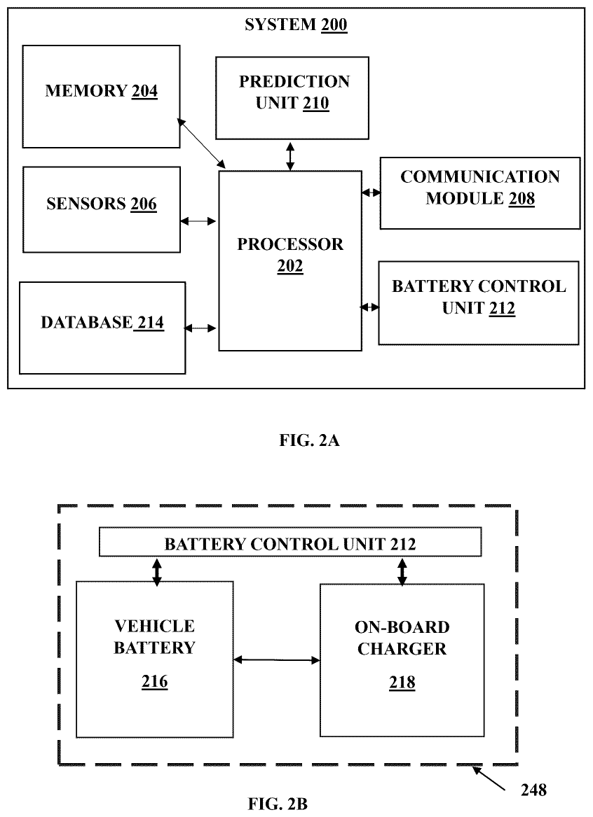

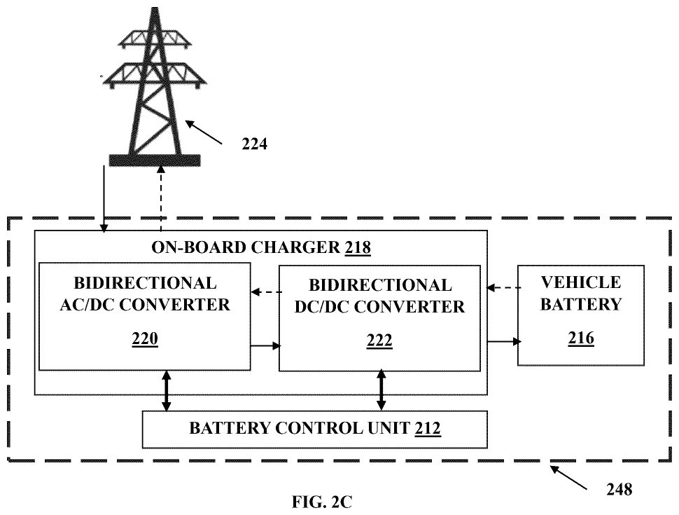

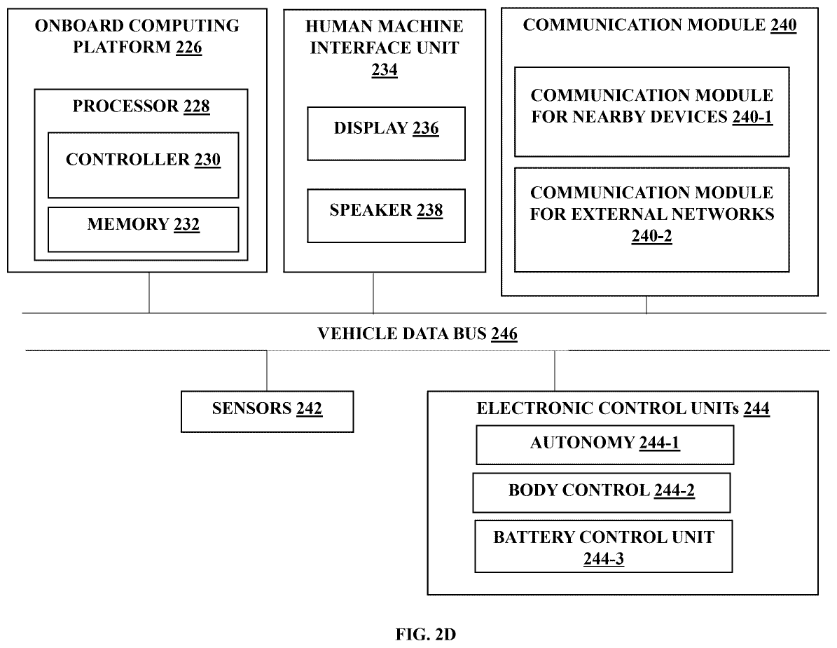

Referring to FIG. 1, network 100 renewable energy sources comprise one or more wind turbines 108-A generating electricity from the wind, one or more solar panels 108-B generating electricity from the sun, and one or more water turbines 108-C generating electricity from the water. Network 100 further comprises conventional power plants 108-D producing electrical energy from fossil fuels such as coal, oil, or natural gas. Energy source 102 is powered by both the renewable energy sources and conventional power plants. During peak times, e.g., 9 AM to 6 PM, the need for electricity may be more and there may be an overload at the energy source. In such times, to stabilize the overload occurring at the energy source/grid, the energy source may accept power back from the vehicles. In some embodiments, the vehicles may be physically present in an area served by the energy source. Vehicles 104-A, 104-B plugged into charging stations 106-A, 106-B may notify energy source 102 of an availability of additional charge for discharging. Based on the amount of energy required at energy source 102, a monetary compensation may be decided by the energy source, or a server, associated with the energy source and information comprising the monetary compensation, i.e., pricing per unit of charge along with a requirement of the number of units of charge available for discharging. A system associated with the vehicle or a vehicle system 200 of FIG. 2A receives the information and schedules a time of discharge for discharging from the vehicle battery back to the grid. In some embodiments, if the monetary compensation from the energy source is not satisfactory, the vehicle system adaptively modifies its wakeup frequency to check for maximum monetary compensation provided by the energy source.

In some embodiments, each of the electric vehicle (EV) is operable to be in at least one of: hibernation mode and a standby mode, wherein the hibernation mode comprises the EV in a sleep state with the battery in non-discharging condition and the standby mode comprises EV in an active state, wherein in the active state the vehicle is operable to receive the information associated with the energy requirement in the energy source and perform discharging of the battery based on the scheduled time of discharge

In an embodiment, the system determines a frequency of wakeup for transitioning the EV from the hibernation mode to the standby mode to receive the information associated with the energy requirement in the energy source.

In an embodiment, the system determines, based on the received information, the presence of monetization opportunity associated with discharging the vehicle battery; and adjusts the frequency of wakeup based on the monetization opportunity in the received information.

In an embodiment, the vehicle battery discharges a stored charge to the energy source based on the scheduled time of discharge.

In some embodiments, the vehicle may be connected to a plurality of energy sources, for example, a power grid, a smart grid, a micro grid, a vehicle charging station, and a home-based vehicle charger. The vehicle system may receive pricing information from the plurality of energy sources and may compare them to determine which of the plurality of energy sources is providing a maximum pricing for the discharge. The vehicle system may then schedule a time of discharge and discharge from the vehicle battery to the energy source proving maximum pricing to maximize the monetary value.

It would be appreciated by a person ordinarily skilled in the art that network 100 is not restricted to only the components shown in FIG. 1 and may include various other components.

FIG. 2A illustrates a block diagram of a system for adaptively adjusting a frequency of waking up for discharging energy to the energy source/grid according to an embodiment.

System 200 comprises processor 202, memory 204, sensors 206, communication module 208, prediction unit 210, battery control unit 212, and database 214.

Referring to FIG. 2A, processor 202 may be a high-performance, multi-core CPU or system-on-chip (SoC) solution to process vast amounts of data. In some embodiments, processor 202 processes data from sensors 206 and prediction unit 210 and other inputs to make real-time decisions related to adjusting a frequency of wakeup for discharging from a vehicle battery back to the energy source. Processor 202 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 202 interacts and exchanges data with one or more of the other components or modules of the system, for example, memory 204, sensors 206, communication module 208, prediction unit 210, battery control unit 212, and database 214.

In an embodiment, the system is operable to receive information associated with an energy requirement in an energy source; determine, based on the information, a presence of monetization opportunity associated with discharging a vehicle battery; and schedule a time of discharge to maximize a monetary value.

In an embodiment, the vehicle battery comprises a battery associated with electric vehicles (EVs).

In some embodiments, the vehicle comprises a battery module. The battery module comprising battery control unit 212 operatively coupled to a vehicle battery and an on-board charger is illustrated below with reference to FIG. 2B. In an embodiment, the battery control unit is operable to control the operation of the on-board charger for charging and discharging the vehicle battery.

Referring to FIG. 2A, memory 204 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 2A, sensors 206 may comprise various sensors such as a temperature sensor, ultrasonic sensors, LIDAR sensors, radar sensors, camera-based sensors, IR sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In some embodiments, communication module 208 facilitates communication between different modules within system 200, communication between the vehicle and other devices, other vehicles, and other infrastructure components, for example, grid.

Referring to FIG. 2A, in some embodiments, database 214 may store data associated with various sensors 206, prediction unit 210, and battery control unit 212. In some embodiments, database 214 may be locally present in vehicle system 200 or may be present in a server associated with a manufacturer of the vehicle or in a cloud server. Processor 202 may fetch the data from the database to determine a frequency of wakeup for transitioning the vehicle from the hibernation mode to the standby mode to enable discharging. Further, database 214 may also store the determined frequency of wakeup and a scheduled time of discharge.

Referring to FIG. 2a, communication module 208, prediction unit 210, and battery control unit 212 are coupled to processor 202. Communication module 208 is operable to communicate with external devices such as energy source 102 of FIG. 1 and receive information related to monetary benefits provided by the energy source in exchange for stored charge. In some embodiments, communication module 208 notifies the energy source of the availability of charge in the vehicle for discharging. In an embodiment, the information received by the processor comprises at least one of: number of units of charge required at the energy source and a price per unit of charge quoted by the energy source, wherein the number of units of charge required at the energy source is based on at least one of: availability of charge at the energy source, number of vehicles connected to the energy source for discharging, and a time of day. In an embodiment, the availability of charge at the energy source is based on the amount of energy provided by the one or more renewable energy sources associated with the energy source, the amount of energy generated by the conventional power plant, and the number of loads that needs to be serviced by the energy source. For example, during peak times, i.e., the time of the day between 9 AM to 6 PM, the energy source may be overloaded as there will be more demand. In such times, the energy source may require more energy and therefore may quote a higher price per unit of charge to be received.

In some embodiments, prediction unit 210 includes a machine learning model communicatively coupled to processor 202. Processor 202 is operable to receive information associated with an energy requirement in an energy source; and transmit the information to the machine learning model, wherein the machine learning model is operable to: predict, based on the information, a time of discharge to maximize a monetary value for discharging a battery associated with a vehicle; and estimate, based on the time of discharge, a frequency of wakeup for the vehicle.

In some embodiments, processor 202 is further operable to transmit, based on the wakeup cycle, a wakeup signal to one or more components in the vehicle to transition the vehicle from the hibernation mode to the standby mode, wherein the vehicle in the standby mode discharges the stored charge to the energy source to maximize the monetary benefit.

In an embodiment, processor 202 determines, based on the received information, the presence of monetization opportunity associated with discharging the vehicle battery; and adjusts the frequency of wakeup based on the monetization opportunity in the received information. For example, processor 202 may send wakeup signals at a particular frequency, i.e., wakeup cycle, to one or more components (e.g., communication module 208) in the vehicle to receive the information and determine based on the received information that the energy source currently requires less energy and is providing a lesser compensation amount. However, prediction unit 210 predicts that after one hour the energy source is likely to require more energy and provide a better monetary compensation. In such a case, the vehicle may be required to wakeup only when the energy source is providing maximum monetary compensation. Therefore, processor 202 modifies/adjusts the frequency of wakeup, i.e., the frequency of sending wakeup signals to the one or more components to transition from the hibernation mode to the standby mode. In other words, processor 202 adaptively adjusts the frequency of wakeup or the wakeup cycle based on when a maximum monetization value is predicted to be obtained for discharging.

In an embodiment, upon determining a time to maximize the monetary gain or obtain maximum monetary benefit for charge transfer, processor 202 may schedule a time of discharge for discharging the stored charge from the vehicle to the energy source. Further, processor 202 modifies the frequency of wakeup such that battery control unit 212 is woken up or turned on to proceed with discharging only when maximum monetization value is obtained. Thereby, the vehicle does not lose charge in waking up unnecessarily. Further, upon every wakeup, system 200 receives information from the energy source or a server or a cloud server or a cloud platform and based on the information adjusts the frequency of wakeup to obtain maximum monetization gain from the discharging.

In one embodiment, prediction unit 210 may be embedded into vehicle system 200. In another embodiment, prediction unit 210 may be associated with the server or the cloud platform or the cloud server.

FIG. 2B shows a block diagram of a battery module in a vehicle according to an embodiment.

Referring to FIG. 2B, battery module 248 comprising battery control unit 212 operatively coupled with vehicle battery 216 and on-board charger or on-board vehicle charger 218 is shown. In some embodiments, the vehicle battery is coupled to the on-board vehicle charger. Battery control unit 212 may perform one or more control and monitoring operations associated with vehicle battery 216 and on-board charger 218. In some embodiments, vehicle battery 216 includes a plurality of battery modules comprising one or more battery cells. Battery control unit 212 may regulate the amount of electrical energy stored and discharged by the plurality of battery modules, perform load balancing in the one or more battery cells, control charging and discharging of the one or more battery cells, determine a charge level associated with the plurality of battery modules, and determine a charge level available for discharging from the battery modules.

Referring to FIG. 2B, on-board charger 218 enables charging and discharging the vehicle battery 216 when the vehicle is plugged in. In an embodiment, the on-board vehicle charger comprises a bidirectional charger, wherein the bidirectional charger provides charging of the vehicle battery from the energy source and discharging from the vehicle battery to the energy source.

Referring to FIG. 2B, in some embodiments, processor 202 of FIG. 2A transmits a wakeup signal to battery control unit 212 thereby enabling the battery control unit to control the operation of the on-board charger to perform at least one of charging the vehicle battery or discharging from the vehicle battery. In some embodiments, the processor may be connected with a wakeup control circuit. The wakeup control circuit is operable to send wakeup signals to the communication module and the battery control unit during the wakeup cycle. For example, the processor may command the wakeup control circuit to wakeup the communication module to receive information from the energy source based on an initial frequency of wakeup. Further, based on the presence of monetization opportunity in the received information, the processor may schedule a time of discharge and may command the wakeup control circuit to wakeup the battery control unit during the scheduled time of discharge. The battery control unit may further control the operation of the on-board charger to discharge the stored energy from the vehicle battery to the energy source based on the scheduled time of discharge.

FIG. 2C illustrates a functional block diagram of an on-board charger in the battery module according to an embodiment.

Referring to FIG. 2C, on-board charger 218 comprises bi-direction alternating current (AC) to direct current (DC) converter 220 and bi-directional DC-DC converter 222. The two bidirectional converters enable both grid to vehicle (G2V) or energy source to vehicle communication and vehicle to anything (V2X) communication. In some embodiments, the operation of on-board charger 218 is controlled by one or more control signals from the battery control unit. In an embodiment, battery control unit 212 provides a control signal to enable G2V communication. The power from grid 224 is converted from AC to DC using bi-directional AC-DC converter 220, wherein the converted DC is stepped down using bi-directional DC-DC converter 222 for charging the vehicle battery. In another embodiment, battery control unit 212 provides a control signal to enable V2X communication or discharging charge from the vehicle to the grid or energy source. The charge from the vehicle battery is up converted using bi-directional DC-DC converter 222, wherein the up converted DC signal is converted to AC using bi-directional AC-DC converter 220. In some embodiments, the processor sends wakeup signals to the battery control unit to control both the charging (e.g., G2V communication) and the discharging (e.g., V2X communication) operations, wherein the wakeup signals are sent based on the adaptively modified wakeup cycles.

FIG. 2d illustrates a block diagram of various electronic components of the vehicle according to an embodiment.

Referring to FIG. 2D, the vehicle comprising various electronic components, such as, onboard computing platform 226, human-machine interface (HMI) unit 234, communication module 240, sensors 242, electronic control units (ECUs) 244, and vehicle data bus 246, is shown. FIG. 2D illustrates an example architecture of some of the electronic components, as shown in FIG. 2A. Onboard computing platform 226 comprises processor 228 (also referred to as a microcontroller unit or a controller) and memory 232. In the illustrated example, processor 228 of the onboard computing platform is structured to comprise controller 230. In other examples, controller 230 is incorporated into another ECU with its own processor and memory. The processor may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 232 comprises multiple kinds of memory, particularly volatile memory, and non-volatile memory. Memory 232 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 232, the computer-readable medium, and/or within processor 228 during execution of the instructions.

HMI unit 234 provides an interface between the vehicle and a user. HMI unit 234 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 236 (e.g., a heads-up display, a center console display such as a liquid crystal display (LCD), an organic light emitting diode (OLED) display, a flat panel display, a solid state display, etc.), and/or speaker 238. For example, the display, the speaker, and/or other input and output device(s) of HMI unit 234 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 236.

Sensors 242 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 242 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

Referring to FIG. 2D, ECUs 244 monitor and control the subsystems of the vehicle. For example, ECUs 244 are discrete sets of electronics that comprise their own circuit(s) (e.g., integrated circuits, microprocessors, memory, storage, etc.) and firmware, sensors, actuators, and/or mounting hardware. ECUs 244 communicates and exchanges information via vehicle data bus 246. Additionally, the ECUs may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus.

In the illustrated example, ECUs 244 comprise autonomy unit 244-1, body control module 244-2, and wakeup monitor module 244-3. For example, autonomy unit 244-1 is operable to perform autonomous and/or semi-autonomous driving maneuvers (e.g., defensive driving maneuvers) of the vehicle based upon, at least in part, instructions received from controller 230 and/or data collected by sensors 242 (e.g., object detection sensors). Further, body control module 244-2 controls one or more subsystems throughout the vehicle, such as power windows, power locks, an immobilizer system, power mirrors, etc. For example, body control module 244-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, battery control unit 244-3 is operable to control the bi-directional on-board charger for charging and discharging the vehicle battery based on wakeup signal from the processor. The processor provides the wakeup signals based on wakeup cycles estimated, by the prediction unit, to provide a maximum monetary benefit.

Referring to FIG. 2D, vehicle data bus 246 communicatively couples communication module 240, onboard computing platform 226, HMI unit 234, sensors 242, and ECUs 244. In some examples, vehicle data bus 246 comprises one or more data buses. Vehicle data bus 246 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 2D, communication module 240 may comprise a near field communication module or a communication module for nearby device 240-1 and far field communication module or communication module for external network 240-2. Communication module for nearby devices 240-1 is operable to communicate with other nearby communication devices. In an example, communication module 240 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 240-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module 240-2 is operable to communicate with external networks. For example, communication module 240-2 comprises hardware (e.g., processors, memory, storage, antenna, etc.) and software to control wired or wireless network interfaces. In the illustrated example, the communication module 240-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 240-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 244-1 of the illustrated example is operable to perform autonomous and/or semi-autonomous driving maneuvers, such as defensive driving maneuvers, for the vehicle. For example, autonomy unit 244-1 performs the autonomous and/or semi-autonomous driving maneuvers based on data collected by sensors 242. In some examples, autonomy unit 244-1 is operable to operate a fully autonomous system, a park-assist system, an advanced driver-assistance system (ADAS), and/or other autonomous system(s) for the vehicle.

Further, in the illustrated example, controller (or control module) 230 is operable to monitor an ambient environment of the vehicle. For example, to enable autonomy unit 244-1 to perform autonomous and/or semi-autonomous driving maneuvers, the controller collects data that is collected by sensors 242 of the vehicle. In some examples, the controller collects location-based data via communication module 240-1 and/or another module (e.g., a GPS receiver) to facilitate the autonomy unit in performing autonomous and/or semi-autonomous driving maneuvers. Additionally, the controller collects data from (i) adjacent vehicle(s) via communication module 240-1 and V2V communication and/or (ii) roadside unit(s) via communication module 240-1 and V2I communication to further facilitate autonomy unit 244-1 in performing autonomous and/or semi-autonomous driving maneuvers.

According to an embodiment, the communication module supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

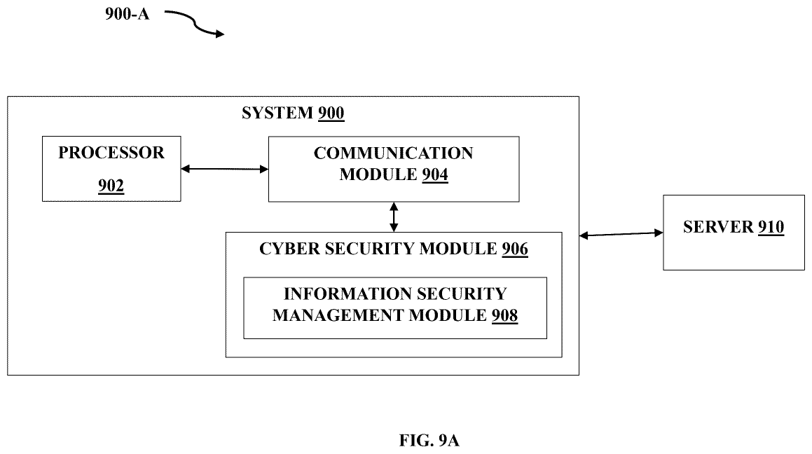

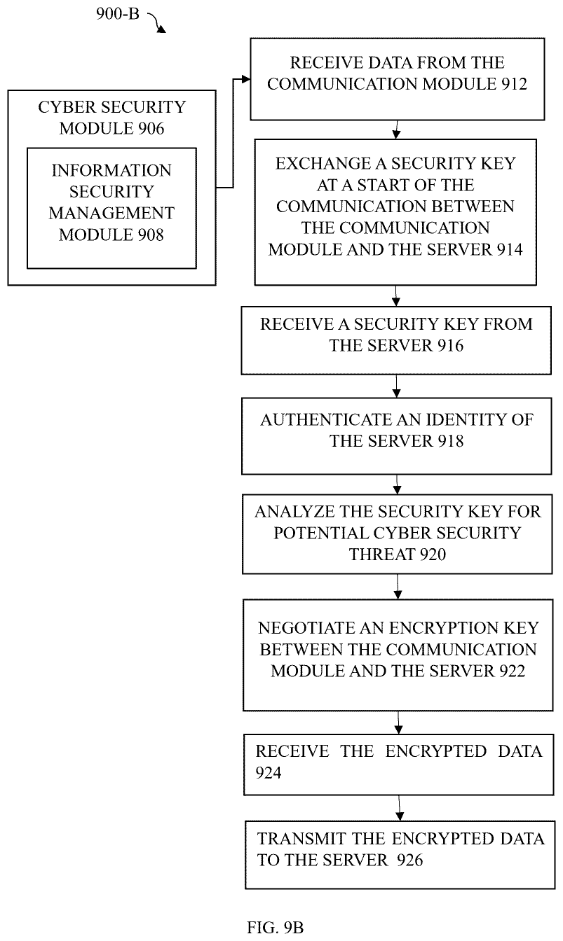

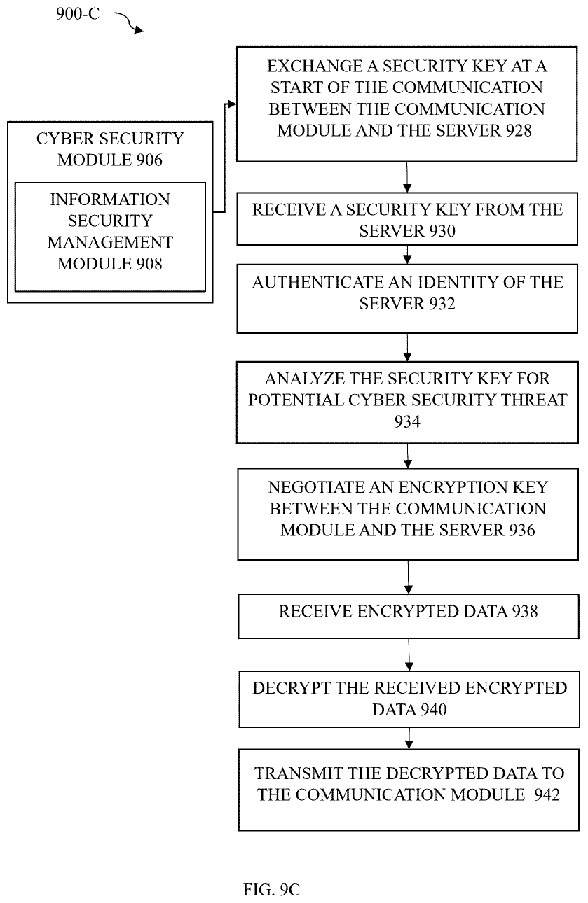

In an embodiment, communication module 240 may comprise a cyber security module 906 (shown in FIG. 9A). In some embodiments, communication module 240 may communicate with cyber security module 906 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

In some embodiments, communication module 240 may receive information associated with charge requirement at the energy source and a monetary benefit provided for discharging charge back to the energy source. Communication module 240 may communicate the received information to the prediction unit (e.g., a machine learning model within the processor) to predict a time for maximizing the monetary opportunity for discharging. The prediction unit further estimates, based on the time, a modified frequency to wakeup the communication module to receive an updated information associated with the charge requirement at the energy source.

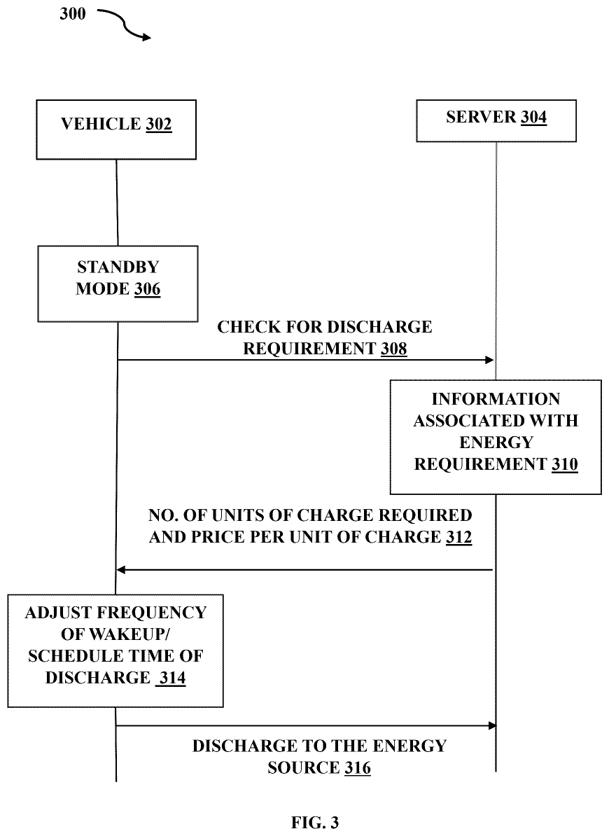

FIG. 3 illustrates message flow diagram 300 between the vehicle and a server according to an embodiment.

Referring to FIG. 3, vehicle 302 in communication with server 304 is shown. In an embodiment, server 304 may be associated with the energy source. In some embodiments, vehicle 302 may send a notification to server 304 checking for any discharge requirement at the energy source. Server 304 may determine an energy requirement at the energy source and also a price per unit of charge provided for discharging. The server may transmit the energy requirement information and the pricing information to the vehicle. The vehicle may process the energy requirement information and the pricing information and determine whether to modify the frequency of wakeup or schedule a discharge time for discharging charge to the energy source. In some embodiments, vehicle 302 may transition from the hibernation mode to the standby mode 306 and send a notification 308 to the server to check if there is any charge requirement at the energy source. Server 304 may check for information associated with the energy source 310. Server 304 may transmit a message 312 comprising number of units of charge required at the energy source and price per unit of charge provided for discharging to the vehicle. Vehicle 302 may determine, based on message 312, when a maximum monetary gain can be obtained and accordingly adjust the frequency of wakeup or schedule a time of discharge 314 to start discharging 316 the stored charge to the energy source. For example, if the vehicle determines from the message 312 that a maximum monetization benefit may be achieved by discharging at the current time, the vehicle may schedule a time of discharge and start discharging the vehicle battery. On the other hand, if the vehicle determines that a maximum monetization benefit may be achieved after a few more hours, the vehicle may update, i.e., modify/adjust the frequency of wakeup. In an embodiment, the vehicle may keep checking for the information associated with the energy requirement based on the modified frequency of wakeup and schedule the time of discharge to maximize the monetary gain from discharging.

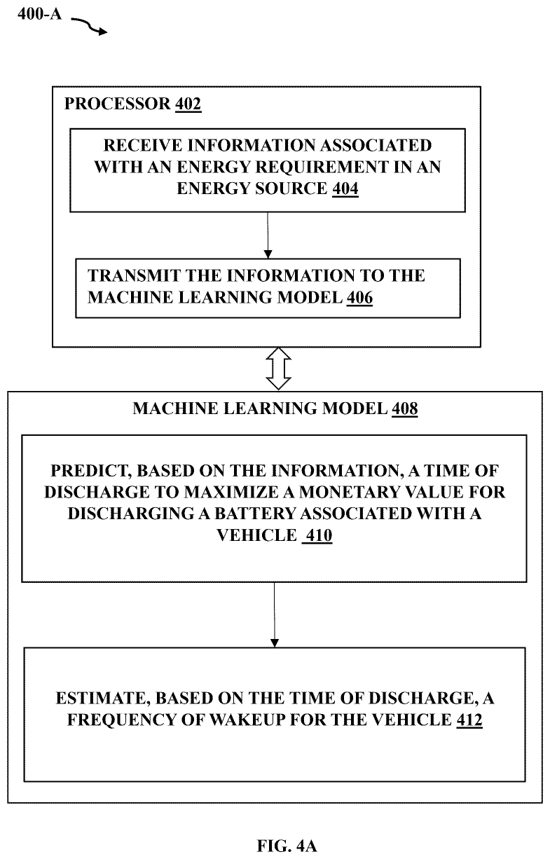

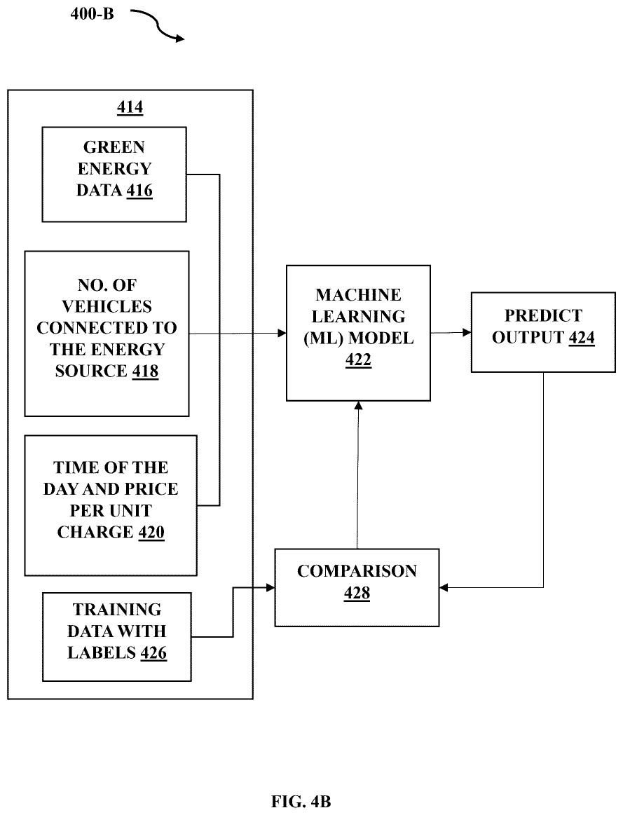

FIG. 4A illustrates block diagram 400-A of a system for estimation of frequency of waking up for discharging energy to the grid according to an embodiment.

Referring to FIG. 4A, processor 402 communicatively coupled with machine learning model 408 is shown. In some embodiments, processor 402 is operatively coupled to a memory, wherein the memory comprises processor-executable instructions, which upon execution, cause the processor to: receive, at step 404, information associated with the energy requirement in the energy source; and transmit, at step 406, the information to machine learning model 408. In some embodiments, the machine learning model is operable to: predict, at step 410, based on the information, a time of discharge to maximize a monetary value for discharging a battery associated with the vehicle to the energy source; and estimate, at step 412, based on the time of discharge, a frequency of wakeup for the vehicle.

In some embodiments, the processor may transmit, based on the frequency of wakeup, a wakeup signal to one or more components (e.g., the communication module, the battery control unit) in the vehicle to transition the vehicle from the hibernation mode to the standby mode. In some embodiments, upon transition from the hibernation mode to the standby mode, the processor may receive an update associated with the energy requirement in the energy source and the machine learning model may predict a time of discharge based on the updated energy requirement and estimate the frequency of wakeup based on the prediction.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In some embodiments, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In some embodiments, the machine learning model has a feedback loop, wherein an output from a previous step is fed back to the machine learning model in real-time to improve the performance and accuracy of the output of a next step.

In some embodiments, the machine learning model has a feedback loop, wherein the learning is further reinforced with a reward for each true positive of the output of the system.

In some embodiments, the machine learning model comprises a recurrent neural network model.

FIG. 4B illustrates an example block diagram 400-B for an Artificial Intelligence and Machine Learning (AI/ML) model used in a system for adaptively adjusting the frequency of waking up for discharging energy to the grid according to an embodiment.

Referring to FIG. 4B, the machine learning model 414 may take as input any data associated with green energy data 416, number of vehicles connected to the energy source 418, time of the day and current price per unit charge 420 and learn to identify features within the data that are predictive of a time of discharge and frequency of wakeup estimations. Training data with labels 426 may comprise, for example, a historical data of monetary values provided by the energy source for earlier discharges of the vehicle battery based on the time of the day, minimum battery power required for discharging, a charge level required by the vehicle for transitioning from the hibernation mode to the standby mode, battery plug-in information, battery age information, etc. The training data, along with a current energy requirement at the energy source, may be transmitted to the cloud for determining to adjust the frequency of wakeup. The systems and methods of the present disclosure may also provide data analytics information that may be used later to improve the prediction accuracy of scheduling the time of discharge and the estimation accuracy of the frequency of wakeups.

In an embodiment, during training, machine learning model 422 may process the training data sample (e.g., green energy data 416, number of vehicles connected to the energy source 418, time of the day and price per unit charge 420), and, based on the current parameters of machine learning model 422, predict output 424 which may be an estimation of the frequency of wakeup to conserve the battery charge from getting used for unnecessarily entering the standby mode. In an embodiment, the real-time sensor data may be processed using one or more machine learning models 422, trained and based on similar types of data to correctly estimate a frequency of wakeup during hibernation to conserve the battery charge level. For example, comparison 428 may be based on a loss function that measures a difference between the predicted/detected output and training data with labels 426. Based on the comparison at 428 or the corresponding output of the loss function, a training algorithm may update the parameters of machine learning model 422 with the objective of minimizing the differences or loss between subsequent predicted output 424 and corresponding labels 426. By iteratively training in this manner, machine learning model 422 may “learn” from the different training data samples and become better at predicting output 424. In an embodiment, machine learning model 422 is trained using data which is specific to a battery type and different vehicles for which the model is used for predicting adjustments to the settings to provide accurate estimation of the frequency of wakeup. In an embodiment, machine learning model 422 is trained using data which is general to the different battery types and is used for predicting adjustments for prediction of frequency of wakeup. In an embodiment, the monetary value may be given weights and provided as an input to the AI/ML system.

Through training, machine learning model 422 may learn to identify predictive and non-predictive features and apply the appropriate weights to the features to optimize detecting and predictive accuracy of machine learning model 422. In embodiments where supervised learning is used and each training data sample has a label, the training algorithm may iteratively process each training data sample and generate a predicted output 424. Any suitable machine learning model and training algorithm may be used, including, e.g., neural networks, decision trees, clustering algorithms, and any other suitable machine learning techniques. Once trained, machine learning model 422 may take input data and detect the objects along with their corresponding confidence score. In an embodiment, machine learning model 422 is an artificial neural networks (ANN) model.

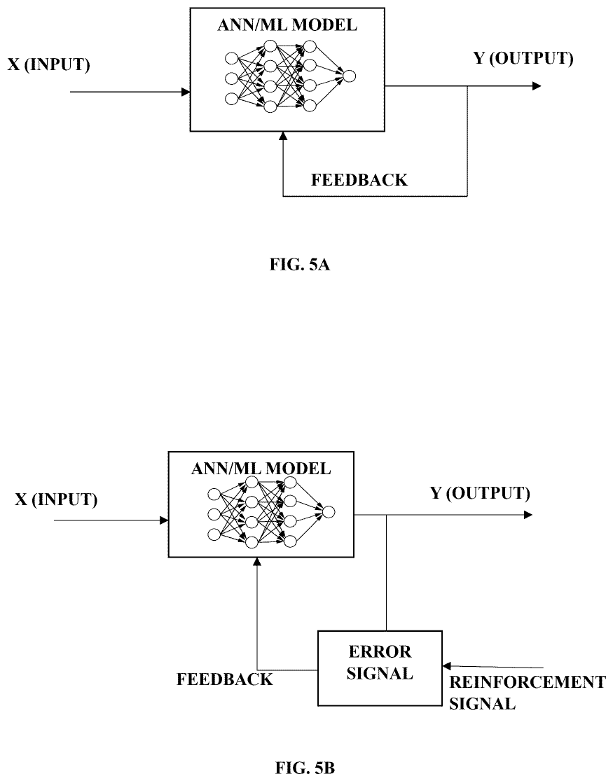

FIG. 5A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data associated with green energy data 416, number of vehicles connected to the energy source 418, time of the day and price per unit charge 420 and output data may comprise estimation of the frequency of wakeup. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may be predictions of a time of discharge and estimation of frequency of wakeup based on the inputs which may be data associated with green energy data 416, number of vehicles connected to the energy source 418, time of the day and price per unit charge 420.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments needs to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) prediction for scheduling a time of discharge and (ii) estimation of frequency of wakeup.

FIG. 5B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

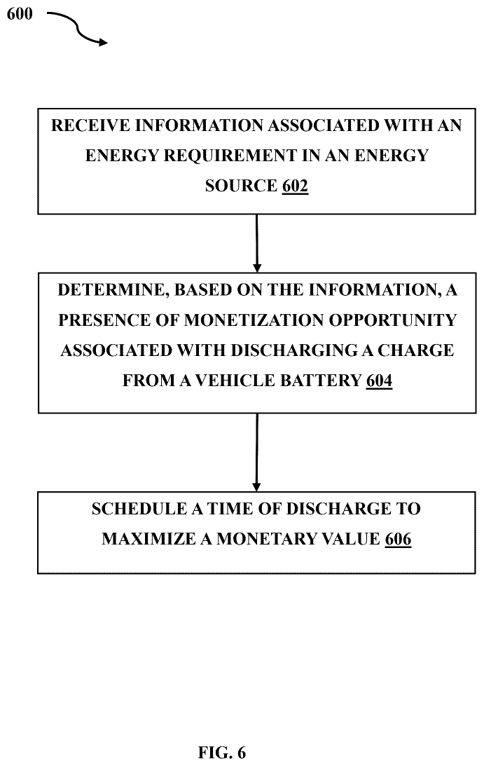

FIG. 6 illustrates a flow chart describing a method for adaptively adjusting a frequency of waking up for discharging energy to the grid according to an embodiment.

In some embodiments, method 600 may be carried out by a processor using instructions stored in a memory that, when executed, cause the processor to carry out method 600. In an embodiment, method 600 may be performed by system 200 as shown in FIG. 2A.

Referring to FIG. 6, method 600 may, at step 602, receive information associated with an energy requirement in an energy source. In an embodiment, the information received comprises at least one of: number of units of charge required at the energy source and a price per unit of charge quoted by the energy source, wherein the number of units of charge required at the energy source is based on at least one of: availability of green energy at the energy source, number of vehicles connected to the energy source for discharging, and a time of day. Method 600 may, at step 604, determine, based on the information, a presence of monetization opportunity associated with discharging a vehicle battery. Method 600 may, at step 606, schedule a time of discharge to maximize a monetary value. In an embodiment, the vehicle battery discharges a stored charge to the energy source based on the scheduled time of discharge.

In some embodiments, method 600 may further determine a frequency of wakeup for transitioning the electric vehicle (EV) from the hibernation mode to the standby mode to receive the information associated with the energy requirement in the energy source and adjust the frequency of wakeup based on the monetization opportunity in the received information.

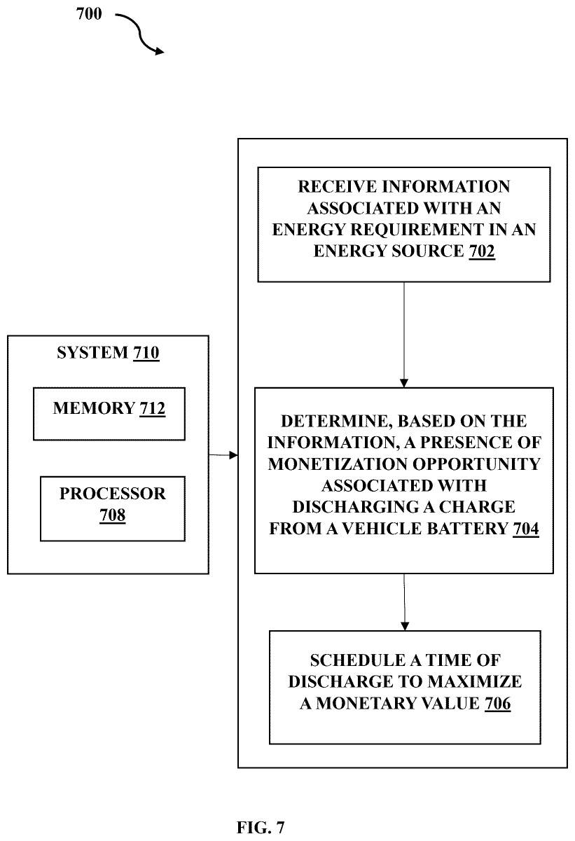

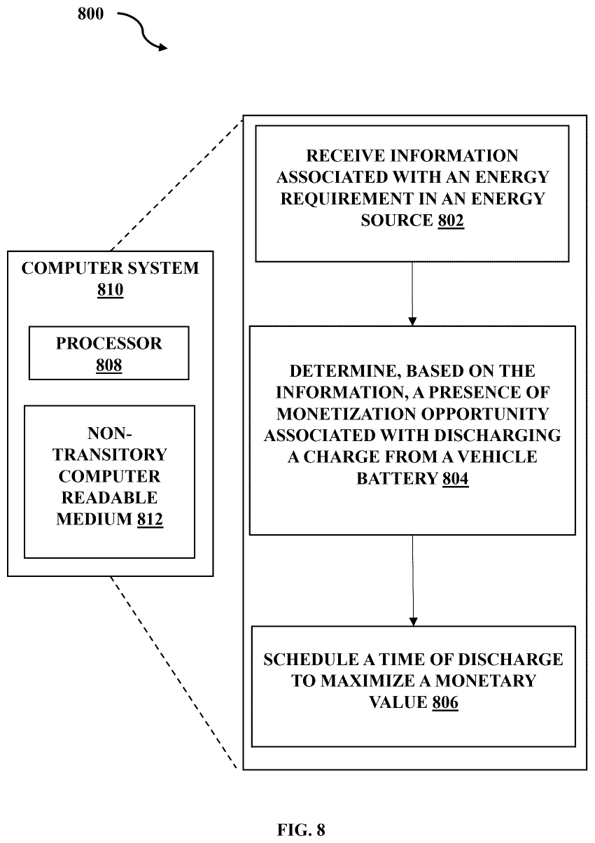

FIG. 7 illustrates block diagram 700 of the system implementing the method for adaptively adjusting a frequency of waking up for discharging energy to the grid according to an embodiment. According to an embodiment, disclosed is system 710 comprising processor 708; and memory 712, wherein memory 712 storing processor-executable instructions, which on execution, cause the processor to: receive information associated with an energy requirement in an energy source 702, determine, based on the information, a presence of monetization opportunity associated with discharging a vehicle battery 704, and schedule a time of discharge to maximize a monetary value 706. In an embodiment, the vehicle battery discharges a stored charge to the energy source based on the scheduled time of discharge.

In some embodiments, the processor-executable instructions, which on execution, cause the processor to: determine a frequency of wakeup for transitioning the electric vehicle (EV) from the hibernation mode to the standby mode to receive the information associated with the energy requirement in the energy source and adjust the frequency of wakeup based on the monetization opportunity in the received information.

In an embodiment, the information received comprises at least one of: number of units of charge required at the energy source and a price per unit of charge quoted by the energy source.

In an embodiment, the number of units of charge required at the energy source is based on at least one of: availability of charge at the energy source, number of vehicles connected to the energy source for discharging, and a time of day.

In an embodiment, the energy source comprises at least one of a power grid, a smart grid, a micro grid, a vehicle charging station, and a home-based vehicle charger.

FIG. 8 illustrates block diagram 800 of the method executed by the non-transitory computer-readable medium for adaptively adjusting a frequency of waking up for information regarding discharging energy to the grid according to an embodiment.

According to an embodiment, disclosed is non-transitory computer-readable medium 812 having stored thereon instructions executable by computer system 810 to perform operations comprising: receiving information associated with an energy requirement in an energy source 802; determining, based on the information, a presence of monetization opportunity associated with discharging a vehicle battery 804; and scheduling a time of discharge to maximize a monetary value 806. A software application may be stored on non-transitory computer-readable medium 812 and executed by processor 808 of computer system 810.

In some embodiments, non-transitory computer-readable medium 812 further comprises instructions to perform operations comprising: determining a frequency of wakeup for transitioning the electric vehicle (EV) from the hibernation mode to the standby mode to receive the information associated with the energy requirement in the energy source and adjust the frequency of wakeup based on the monetization opportunity in the received information.

FIG. 9A shows block diagram 900-A of a cyber security module in view of the system and server according to an embodiment.

Referring to FIG. 9A, system 900 comprising processor 902, communication module 904, cyber security module 906, and information security management module 908 in communication with server 910, is shown. The communication of data between system 900 and server 910 through communication module 904 is first verified by information security management module 908 before being transmitted from system 900 to server 910 or from server 910 to system 900. Information security management module 908 is operable to analyze the data for potential cyber security threats, to encrypt the data when no cyber security threat is detected, and to transmit the data encrypted to system 900 or server 910.

FIG. 9B shows an embodiment of the cyber security module, in accordance with some embodiments of the present disclosure.

Referring to FIG. 9B, method 900-B for securing the data through cyber security module 906 is shown. At step 912, the information security management module is operable to receive data from the communication module. At step 914, the information security management module exchanges a security key at a start of the communication between the communication module and the server. At step 916, the information security management module receives a security key from the server. At step 918, the information security management module authenticates an identity of the server by verifying the security key. At step 920, the information security management module analyzes the security key for potential cyber security threats. At step 922, the information security management module negotiates an encryption key between the communication module and the server. At step 924, the information security management module receives the encrypted data. At step 926, the information security management module transmits the encrypted data to the server when no cyber security threat is detected.

FIG. 9C shows another embodiment of the cyber security module, in accordance with some embodiments of the present disclosure.

Referring to FIG. 9C, method 900-C for securing the data through the cyber security module is shown. At step 928, the information security management module is operable to: exchange a security key at a start of the communication between the communication module and the server. At step 930, the information security management module receives a security key from the server. At step 932, the information security management module authenticates an identity of the server by verifying the security key. At step 934, the information security management module analyzes the security key for potential cyber security threats. At step 936, the information security management module negotiates an encryption key between the communication module and the server. At step 938, the information security management module receives encrypted data. At step 940, information security management module 908 decrypts the encrypted data, and performs an integrity check of the decrypted data. At step 942, information security management module 908 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 9A, identity authentication is first carried out on the system and then on the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the communication between vehicle 302 and server 304 as shown in FIG. 3 may be secured by the cyber security module. Vehicle 302 may include the communication module coupled to the information security management module. A notification of availability of charge in the vehicle battery may be sent to the server through the communication module. The notification may be verified by the information security management module before being transmitted from the vehicle to the server. The information security management module is operable to analyze the data for potential cyber security threats, to encrypt the data when no cyber security threat is detected, and to transmit the data encrypted to the vehicle or the server.

In an embodiment, the server may transmit securely at least one of number of units of energy/charge required by the energy source and the price provided per unit of charge information to the vehicle. The vehicle, upon receiving the information, may modify the frequency of wakeup and schedule a time to discharge and start discharging at the scheduled discharge time.

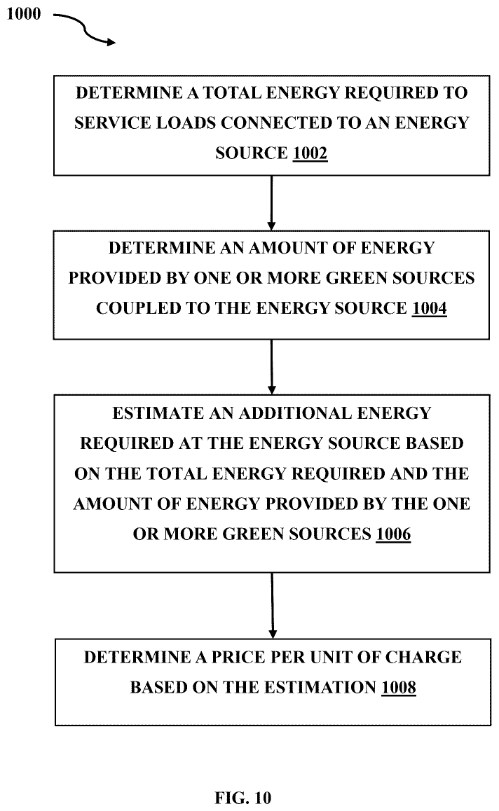

FIG. 10 illustrates a flow chart of a method for determining a pricing per unit of charge according to an embodiment.

In some embodiments, method 1000 may be carried out by a processor using instructions stored in a memory that, when executed, cause the processor to carry out method 1000. In an embodiment, method 1000 may be performed by server 304 as shown in FIG. 3. In another embodiment, method 1000 may be performed by a cloud server. In one another embodiment, method 1000 may be performed by any device associated with the energy source.

Referring to FIG. 10, method 1000 may, at step 1002, determine a total energy required to service loads connected to an energy source. Method 1000 may, at step 1004, determine an amount of energy provided by one or more green sources coupled to the energy source. Further, method 1000 may, at step 1006, estimate an additional energy required at the energy source based on the total energy required and the amount of energy provided by the one or more green sources. Method 1000 may, at step 1008, determine a price per unit of charge based on the estimation.

In some embodiments, method 1000 may transmit the determined price per unit of charge to one or more vehicles associated with the energy source.

### How Technical Solution is a Technological Advancement:

(a) An adaptive wakeup cycle or frequency of wakeup estimation enables conserving a battery power by avoiding unnecessary waking up by the vehicle to determine whether charge is required at the energy source or not.
(b) The present disclosure discusses the frequency of wakeup estimation based on the availability of renewable energy sources providing power to the energy source, the number of vehicles connected to the energy source for discharging, the time of the day, and price per unit charge quoted. Considering all three aspects enables a more accurate estimation of the frequency of wakeup, thereby maximizing the monetary gain and at the same time conserving the battery from being used for unnecessary transitions from the hibernation mode to the standby mode.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-50. (canceled)

51. A system comprising:
a processor; and
a memory operatively coupled to the processor, wherein the memory comprises processor-executable instructions, which on execution, cause the processor to:
receive information associated with an energy requirement in an energy source;
determine, based on the information, a presence of monetization opportunity associated with discharging a vehicle battery; and
schedule a time of discharge to maximize a monetary value.

52. The system of claim 51, wherein the vehicle battery comprises a battery associated with electric vehicles (EVs), wherein electric vehicles (EVs) comprise at least one of: battery electric vehicles (BEVs) and plug-in hybrid electric vehicles (PHEVs).

53. The system of claim 52, wherein each of the electric vehicles (EVs) is operable to be in at least one of: hibernation mode and a standby mode.

54. The system of claim 53, wherein the hibernation mode comprises the electric vehicle (EV) in a sleep state with the battery in non-discharging condition.

55. The system of claim 53, wherein the standby mode comprises the electric vehicle (EV) in an active state operable to perform at least one of:
receive the information associated with the energy requirement in the energy source; and
enable discharging of the battery based on the scheduled time of discharge.

56. The system of claim 53, wherein the processor-executable instructions, which on execution, cause the processor to further:
determine a frequency of wakeup for transitioning the electric vehicle (EV) from the hibernation mode to the standby mode to receive the information associated with the energy requirement in the energy source; and
adjust the frequency of wakeup based on the monetization opportunity in the received information.

57. The system of claim 51, wherein the vehicle battery discharges a stored charge to the energy source based on the scheduled time of discharge.

58. The system of claim 51, wherein the information received comprises at least one of: number of units of charge required at the energy source and a price per unit of charge quoted by the energy source.

59. The system of claim 58, wherein the number of units of charge required at the energy source is based on at least one of: availability of charge at the energy source, number of vehicles connected to the energy source for discharging, and a time of day.

60. The system of claim 59, wherein the energy source comprises at least one of a power grid, a smart grid, a micro grid, a vehicle charging station, and a home-based vehicle charger.

61. The system of claim 51 further comprising:
an on-board vehicle charger coupled to the vehicle battery, wherein the on-board vehicle charger comprises a bidirectional charger.

62. The system of claim 61, wherein the bidirectional charger provides charging of the vehicle battery from the energy source and discharging from the vehicle battery to the energy source.

63. A system comprising:
a processor;
a machine learning model communicatively coupled to the processor; and
a memory operatively coupled to the processor, wherein the memory comprises processor-executable instructions, which on execution, cause the processor to:
receive information associated with an energy requirement in an energy source; and
transmit the information to the machine learning model, wherein the machine learning model is operable to:
predict, based on the information, a time of discharge to maximize a monetary value for discharging a battery associated with a vehicle; and
estimate, based on the time of discharge, a frequency of wakeup for the vehicle.

64. The system of claim 63, wherein the processor-executable instructions, which on execution, cause the processor to further:
transmit, based on the frequency of wakeup, a wakeup signal to one or more components in the vehicle to transition the vehicle from a hibernation mode to a standby mode.

65. A method comprising:
receiving, by a processor, information associated with an energy requirement in an energy source;
determining, by the processor, based on the information, a presence of monetization opportunity associated with discharging a charge from a vehicle battery; and
scheduling, by the processor, a time of discharge to maximize a monetary value.

66. The method of claim 65, wherein the vehicle battery comprises a battery associated with electric vehicles (EVs), wherein electric vehicles (EVs) comprise at least one of: battery electric vehicles (BEVs) and plug-in hybrid electric vehicles (PHEVs).

67. The method of claim 66, wherein each of the electric vehicle (EV) is operable to be in at least one of: hibernation mode and a standby mode.

68. The method of claim 67, wherein the hibernation mode comprises the electric vehicle (EV) in a sleep state with the battery in non-discharging condition.

69. The method of claim 67, wherein the standby mode comprises the electric vehicle (EV) in an active state, wherein in the active state the electric vehicle is operable to perform at least one of:
receive the information associated with the energy requirement in the energy source; and
enable discharging of the battery based on the scheduled time of discharge.

70. The method of claim 67 further comprising:
determining, by the processor, a frequency of wakeup for transitioning the electric vehicle (EV) from the hibernation mode to the standby mode to receive the information associated with the energy requirement in the energy source; and
adjusting, by the processor, the frequency of wakeup based on the monetization opportunity in the received information.
